(19) United States
(12) Patent Application Publication
(10) Pub. No.: US 2009/0114045 A1
(43) Pub. Date: May 7, 2009

(54) Power Take-Off Unit Having Scissor Gears

(76) Inventors: Brian Wilson, Ferndale, MI (US); Kenneth L. Nowaczyk, Brighton, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/933,557

(22) Filed: Nov. 1, 2007

(51) Int. Cl. F16H 37/02

(52) U.S. Cl. 74/11

(57) ABSTRACT

A power take-off assembly for transmitting rotary power includes an impeller shaft connected driveably to a power source, a housing having an opening through a wall of the housing, a pinion secured to the impeller shaft, located in the housing, aligned with the opening, and supported for rotation about an axis, and a first power takeoff idler gear including a first idler gear portion meshing with the pinion, aligned with the opening, and including a first pin extending from a side of the first idler gear portion; a second idler gear portion coaxial with the first idler gear portion, rotatable relative to the first idler gear portion, meshing with the pinion, aligned with the opening, and including a second pin extending from a side of the second idler gear portion toward the first idler gear portion; and an arcuate spring located between said first and second idler gears, and including first and second angularly spaced ends, the first end contacting the first pin and the second end contacting the second pin.

### BACKGROUND OF THE INVENTION

1. Field of the Invention

This invention relates generally to a motor vehicle powertrain and, in particular, to use of the powertrain as a power source for equipment that is onboard or extrinsic to the vehicle.

2. Description of the Prior Art

The engine of a motor vehicle can be used to supply power through a power take-off (PTO) to onboard equipment, such as a hydraulic pump that provides pressure to support and move a snowplow blade or a bucket boom, and to extrinsic equipment, such as a water pump or electric generator at a construction site, ranch or farm.

A conventional PTO is driven downstream of a torque converter turbine, which is hydrokinetically coupled to the engine shaft through an impeller, driveably coupled to the engine. A conventional PTO unit transmits no power when the vehicle is stopped, though the selected position of the transmission gear selector is in either the reverse-range or drive-range. For a conventional PTO to provide power to a user, the transmission must transmit power to its output.

In heavy truck applications, a PTO assembly generally is located axially between a transmission bell housing and the gearbox. But this arrangement does not package well in light trucks. It requires changing the rear position of the transmission, which causes mount/cross and drive shaft complexities, and is incompatible with high volume manufacturing.

A need exists in the light truck industry for a live PTO, i.e., a PTO that is driven directly by the engine output regardless of the operating state of the transmission. The live PTO should manage the effects of backlash in the gear system and operate quietly with little or no gear rattle.

### SUMMARY OF THE INVENTION

A power take-off assembly for transmitting rotary power includes an impeller shaft connected driveably to a power source, a housing having an opening through a wall of the housing, a pinion secured to the impeller shaft, located in the housing, aligned with the opening, and supported for rotation about an axis, and a first power takeoff idler gear including a first idler gear portion meshing with the pinion, aligned with the opening, and including a first pin extending from a side of the first idler gear portion; a second idler gear portion coaxial with the first idler gear portion, rotatable relative to the first idler gear portion, meshing with the pinion, aligned with the opening, and including a second pin extending from a side of the second idler gear portion toward the first idler gear portion; and an arcuate spring located between said first and second idler gears, and including first and second angularly spaced ends, the first end contacting the first pin and the second end contacting the second pin.

The PTO idler gear can be integrated with pump housing or can be a separate drop-in unit that is installed when a customer installs the PTO unit. The live PTO should manage the effects of backlash in the gear system and operate quietly with little or no gear rattle.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a cross sectional side view showing a torque converter, hydraulic pump and PTO unit;

FIG. 2 is a cross section showing a second embodiment of the PTO unit;

FIG. 3 is a partial front view of the transmission oil pump assembly; PTO unit and idler;

FIG. 4 is a schematic diagram showing a motor vehicle powertrain to which the PTO unit can be applied;

FIG. 5 is a cross sectional side view showing a third embodiment of the PTO unit;

FIG. 6 is a side view of a idler scissors gear assembly; and

FIG. 7 is a front side view of the gear assembly of FIG. 6.

### DESCRIPTION OF THE PREFERRED EMBODIMENT

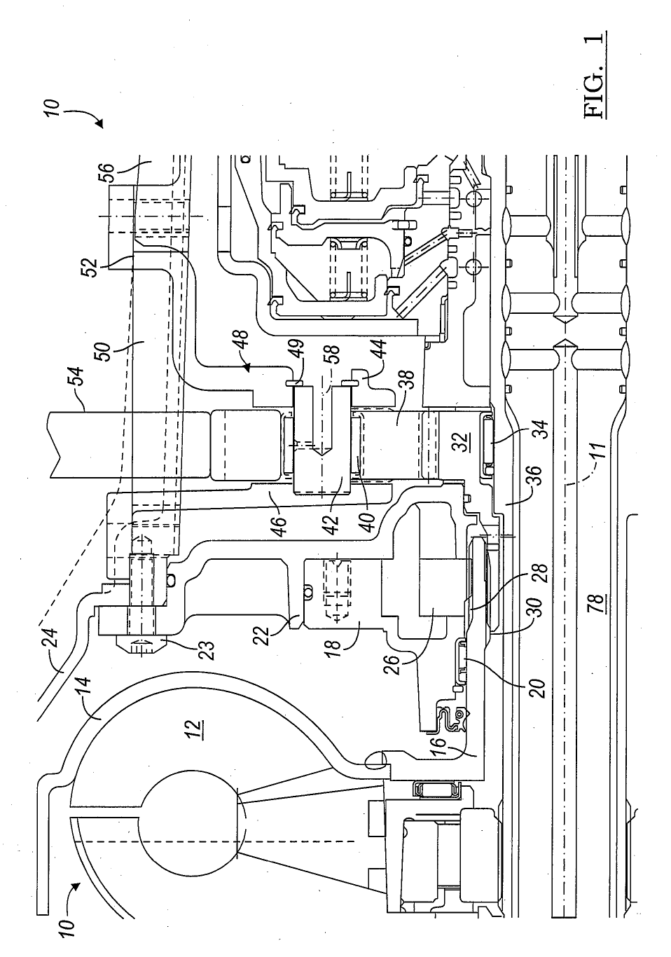

Referring first to FIG. 1, a torque converter 10, located along an axis 11 between an engine and the front of an automatic transmission, includes an impeller 12 surrounded by a torque converter cover 14, which is secured to the blades of the impeller and connected driveably to the crankshaft of the engine. An impeller shaft 16, welded to the cover 14, is supported for rotation on a pump body 18 by a bearing 20. The pump body 18 is fitted into a pump support 22, which is secured by bolts 23 to the front cover 24 of the transmission. The pump body 18 contains a hydraulic pump, whose gear or rotor 26 is connected by an external spline 28 to impeller shaft 16.

An internal spline 30 on impeller shaft 16 connects that shaft to the pinion 32 of a PTO. Pinion 32 is supported by a bearing 34 located on a shoulder of a stator shaft 36, which extends axially from the stator of torque converter 10. PTO pinion 32 meshes with a PTO idler gear 38, which is supported on a bearing 40 and a stub shaft 42, fitted into the lugs 44, 46 of PTO idler gear support 48. A snap ring 49 secures shaft 42 in position on the support 48.

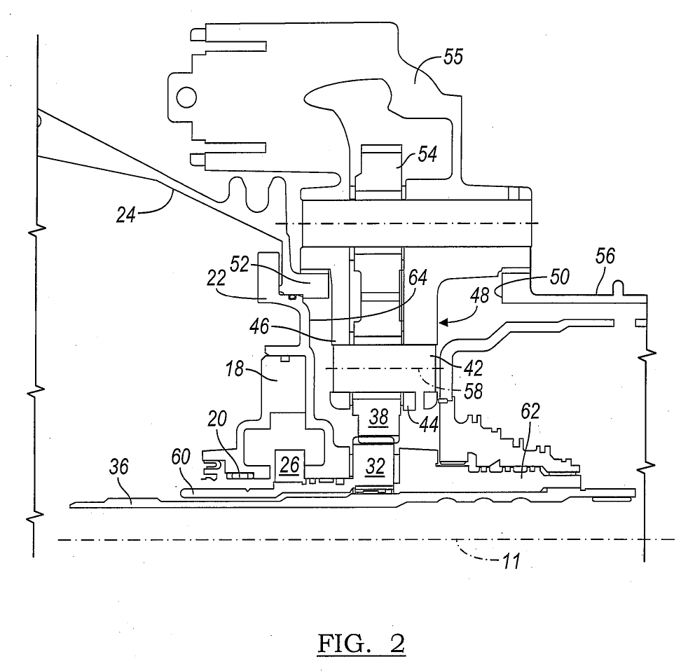

The transmission housing 56 is formed with a covered opening 50 surrounded by a mounting surface 52. The cover is removed when the PTO unit is installed. The idler support 48 is removeably attached to and supported on mounting surface 52 while the PTO is being used. The PTO idler gear 38 is located such that it engages with an output gear 54, located on equipment 55 (seen best in FIG. 2) that is to be driven by the PTO. Output gear 54 extends through the opening 50 into the space enclosed by the transmission housing 56. Front cover 24 may be separate from transmission housing 56 such that the opening 50 is integrated solely in the housing 56.

In operation with the engine running, impeller 12, impeller shaft 16 and PTO pinion 32 are driven by the engine in rotation about axis 11. PTO idler gear 38 is driven by pinion 32 and rotates on the idler support 48 about axis 58. Power from the engine is transmitted through the PTO assembly, PTO idler gear 38 and output gear 54 to the subject equipment

FIG. 2 illustrates a second embodiment, in which the PTO pinion 32 is formed integrally with a pump drive or an impeller shaft 60. A transmission torque converter stator support assembly 62 is spaced axially from the rear face 64 of pump support 22, thereby providing a space in which the PTO pinion 32 is located and the PTO idler gear 38 extends through the opening 50 to engage pinion 32 and gear 54.

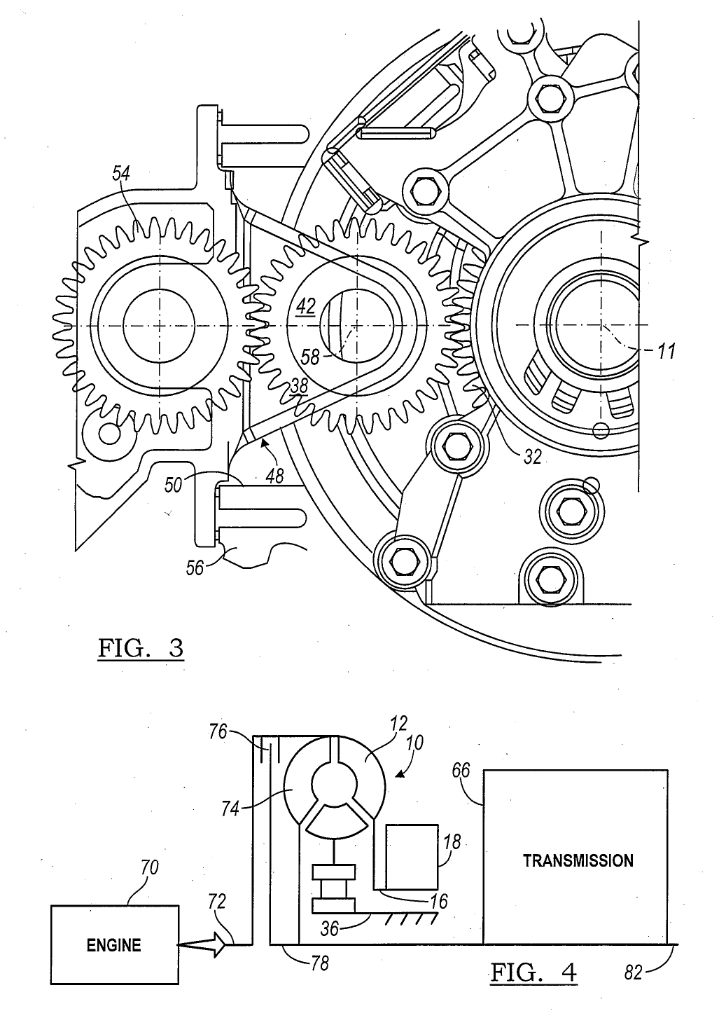

FIG. 3 shows the teeth of PTO pinion 32 meshing with the teeth of PTO idler 38 at a radial line extending from axis 11. External radial access to PTO pinion 32 is provided to PTO idler 38 through the opening 50 in the wall of housing 56.

FIG. 4 is a schematic diagram showing a portion of a vehicle powertrain, whose power source is an engine 70 having a crankshaft 72 driveably connected to the impeller cover and impeller 12. The impeller shaft 16 is connected driveably to the rotor in the pump body 18. A bladed turbine 74 is hydrokinetically coupled to impeller 12 and is driven by hydraulic fluid exiting the impeller. A lock-up clutch 76 engages and disengages alternately in response to control of a transmission controller. When clutch 76 is engaged, a mechanical connection between engine crankshaft 72 and the transmission input shaft 78 is produced, such that the hydrokinetically coupling is inoperative. The input shaft 78 of transmission 66 transmits power to a gear box containing gears, shafts, solenoids, clutch and brakes, which cooperate to produce various gear ratio of the transmission 66. The wheels of the vehicle are driven from the transmission output shaft 82.

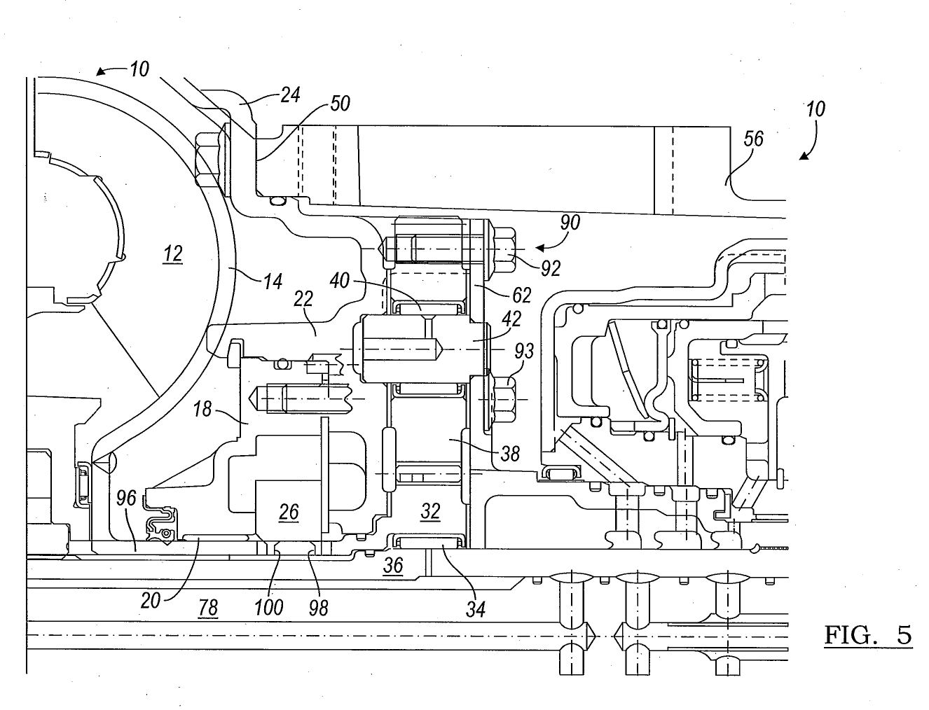

FIG. 5 illustrates a third embodiment in which an idler support 90 is integrated with both the stator support 62 and the pump support 22 by bolts 92, 93 that is secured in position within the transmission 66. The idler gear 38, bearing 40, shaft 42 are not removed from the transmission housing 56 when the PTO is not being used to transmit power. Instead, the output gear 54 is removed from the housing 56 and its engagement with PTO idler gear 38. Then the opening 50 in housing 56 is closed with a cover.

Impeller shaft 96 is formed with teeth 98 at its axial end, which engage teeth 100 formed on the adjacent end of PTO pinion 32, thereby driveably connecting shaft 96 and pinion 32 mutually.

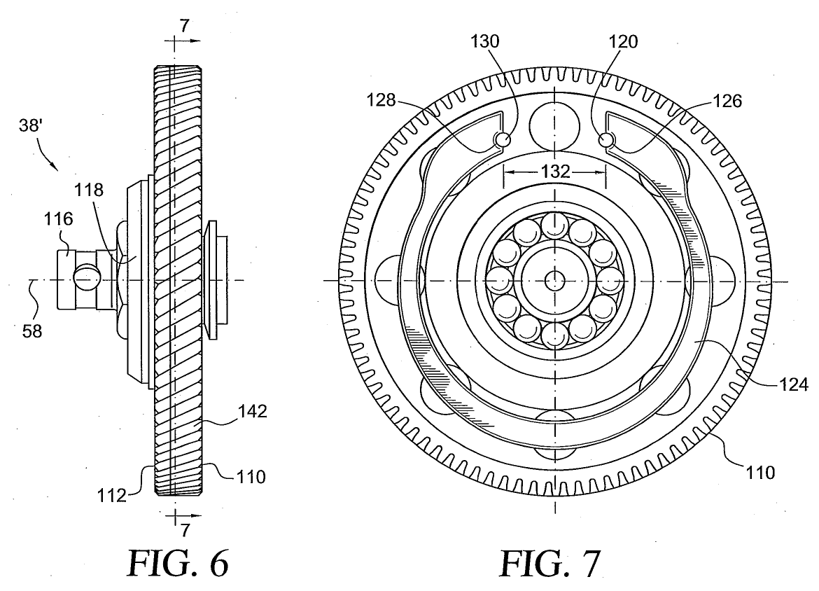

FIGS. 6 and 7 illustrate idler gear 38′ formed as a scissor gear assembly for reducing backlash among the gears it engages. Idler gear 38′ includes a first idler gear portion 110 and a second idler gear portion 112 arranged coaxially about axis 58 and adjacent idler gear portion 110. The first idler gear portion 110 is formed with a circular groove 114 on the side that faces gear portion 112, a boss 116, which passes through a hole 118 formed in gear portion 112, and a pin 120, which project axially toward gear portion 112 from the bottom of the circular groove 114. The second idler gear portion 112 also has a similar groove 114 and a pin 122, which project axially toward gear portion 110 from the bottom of the circular groove of gear portion 112.

A planar spring 124, located in the grooves 114 between idler gear portions 110, 112, includes a first concave end 126, which engages pin 120, and a second concave end 128, which engages pin 130.

With this arrangement, the two pins 120, 130 are locate within a gap 132 between the end surfaces 126, 128 of the spring 14, in side-by-side relationship on a common circle about the axis of the assembly. The components of idler gear 38′ are secured in position by a snap ring located in an annular groove formed in the boss 116 close to end face of the idler gear portion 112.

Although output gear 54 may be located on equipment 55 that is to be driven by the PTO assembly, gear 54 may be, instead a second idler gear, which meshes with the first idler gear 38 and with an output gear that drives the equipment. When a second idler gear is used, it is formed and assembled as described with reference to idler gear 38′.

Although pinion 32, idler gear 38 and gear 54 are shown in FIGS. 1-3 and 5 with spur gear teeth 140, they may be formed, instead, with helical gear teeth 142, as shown in FIGS. 6 and 7.

In accordance with the provisions of the patent statutes, the preferred embodiment has been described. However, it should be noted that the alternate embodiments can be practiced otherwise than as specifically illustrated and described.

What is claimed is:

1. A power take-off assembly for transmitting rotary power from the powertrain of a motor vehicle comprising:
a torque converter for an automatic transmission and including an impeller shaft connected driveably to a power source;
a housing having an opening through a wall of the housing;
a pinion secured to the impeller shaft, located in the housing, aligned with the opening, and supported for rotation about an axis;
a power takeoff idler gear including a first idler gear portion meshing with the pinion, aligned with the opening, and including a first pin extending from a side of the first idler gear portion; a second idler gear portion coaxial with the first idler gear portion, rotatable relative to the first idler gear portion, meshing with the pinion, aligned with the opening, and including a second pin extending from a side of the second idler gear portion toward the first idler gear portion; and an arcuate spring located between said first and second idler gears, and including first and second angularly spaced ends, the first end contacting the first pin and the second end contacting the second pin.

2. The assembly of claim 1 wherein:
the spring is a planar strip;
the first end and the second end are each formed with a concave surface;
the first pin includes a convex outer surfaces that engages the concave surface of the first end; and
the second pin includes a convex outer surfaces that engages the concave surface of the second end.

3. The assembly of claim 1, further comprising:
an idler support for supporting the power takeoff idler gear portions.

4. The assembly of claim 1, further comprising:
an idler support for supporting the power takeoff idler gear portions; and
an output gear meshing with the power takeoff idler gear portions, and aligned with the opening.

5. The assembly of claim 1, further comprising:
a pump support located in the housing;
a gear box of the transmission spaced from the pump support and providing a space therebetween, the pinion and idler gear being located in said space.

6. The assembly of claim 1, wherein the first idler gear portion includes a central boss projecting from a side surface thereof, and said second idler gear portion is formed with a hole sized to receive therein the boss of the first idler gear portion.

7. The assembly of claim 1, further comprising:
an output gear meshing with the power takeoff idler gear.

8. A power take-off assembly for transmitting rotary power from the powertrain of a motor vehicle comprising:
a torque converter for an automatic transmission and including an impeller shaft connected driveably to a power source;
a housing having an opening through a wall of the housing;
a power takeoff gear secured to the impeller shaft, located in the housing, aligned with the opening, and supported for rotation about an axis;
a first idler gear including a first idler gear portion meshing with the pinion, aligned with the opening, and including a first pin extending from a side of the first idler gear portion; a second idler gear portion coaxial with the first idler gear portion, rotatable relative to the first idler gear portion, meshing with the pinion, aligned with the opening, and including a second pin extending from a side of the second idler gear portion toward the first idler gear portion; and a first arcuate spring located between said first and second idler gears, and including first and second ends angularly spaced ends, the first end contacting the first pin and the second end contacting the second pin; and
a second idler gear including a third idler gear portion meshing with the first idler gear, aligned with the opening, and including a third pin extending from a side of the third idler gear portion; a fourth idler gear portion coaxial with the third idler gear portion, rotatable relative to the third idler gear portion, meshing with the with the first idler gear, aligned with the opening, and including a fourth pin extending from a side of the fourth idler gear portion toward the third idler gear portion; and a second arcuate spring located between said third and fourth idler gear portions, and including third and fourth angularly spaced ends, the third end contacting the third pin and the fourth end contacting the fourth pin.

9. The assembly of claim 8, further comprising:
an output gear meshing with the second power takeoff idler gear.

10. The assembly of claim 8 wherein:
the spring is a planar strip;
the first end and the second end are each formed with a concave surface;
the first pin includes a convex outer surfaces that engages the concave surface of the first end;
the second pin includes a convex outer surfaces that engages the concave surface of the second end;
the third end and the fourth end are each formed with a concave surface;
the third pin includes a convex outer surfaces that engages the concave surface of the third end; and
the fourth pin includes a convex outer surfaces that engages the concave surface of the fourth end.

11. The assembly of claim 8, further comprising:
an idler support for supporting the power takeoff idler gear portions.

12. The assembly of claim 8, further comprising:
an idler support for supporting the power takeoff idler gear portions; and
an output gear meshing with the power takeoff idler gear portions, and aligned with the opening.

13. The assembly of claim 8, further comprising:
a pump support located in the housing;
a gear box of the transmission spaced from the pump support and providing a space therebetween, the pinion and the idler gear portions being located in said space.

14. The assembly of claim 8, wherein the first idler gear portion includes a central boss projecting from a side surface thereof, and said second gear portion is formed with a hole sized to receive therein the boss of the first idler gear portion.

15. The assembly of claim 8, wherein the third first idler gear portion includes a central boss projecting from a side surface thereof, and said fourth idler gear portion is formed with a hole sized to receive therein the boss of the third idler gear portion.
